(19) United States
(12) Patent Application Publication
(10) Pub. No.: US 2014/0158673 A1
(43) Pub. Date: Jun. 12, 2014

(54) Voice-Activated Electric-Heating Glove

(71) Applicant: TERRY ELECTRONICS (S.Z.) CO., LTD., ShenZhen City (CN)

(72) Inventor: John Gou, ShenZhen City (CN)

(73) Assignee: TERRY ELECTRONICS (S.Z) CO., LTD., ShenZhen City (CN)

(21) Appl. No.: 13/710,753

(22) Filed: Dec. 11, 2012

(51) Int. Cl. H05B 3/00

(52) U.S. Cl. CPC H05B 3/00
USPC 219/211

(57) ABSTRACT

The present invention claims a voice-activated electric-heating glove, comprising a glove body, a flexible electric heating body arranged inside the glove, power supply, a voice-activated switch that can power on/off the circuit by voice, and a control circuit; wherein the control circuit is electrically connected with the flexible electric heating body, the power supply and the voice-activated switch separately. By means of the voice-activated switch and the built-in control circuit, this glove can realize controlling current and/or voltage from the power supply to the electric heating device through voice, so as to control temperature of the heating glove and power on/off the glove without using hand.

### TECHNICAL FIELD

The present invention relates to a glove, specifically to a electric-heating glove.

### BACKGROUND ART

In cold winter, people always use gloves to keep the hands warm. There are many kinds of materials used to make gloves such as cotton, hair and fur. At the high latitude area, the temperature is very low, the gloves must be very good at keeping warm so the gloves are always very thick, which makes the wearers inconvenient to uses hands. Even the gloves are made of material good at keeping hands warm, they cannot meet the requirement at those high and cold areas, let alone the requirement for the outdoor workers at these areas.

In order to solve the problem, people invented the electric heating gloves that use the portable power supply to provide power to the electric heating device such as resistance wire inside the gloves to make it heat the gloves. As a result, the gloves can be thin and good at effect of keeping warm, which greatly facilitates operation of the users and meets the requirement of keeping hands warm at the high and cold areas. However, because the portable power supply has limited size and charging capacity, if the power supply is continuously used to provide power to gloves, it would be a waste and may cause the problem that there is no power when it is needed; besides, it may cause ambustion to users because of heating accumulation. If a switch can solve this problem, but the users cannot turn on/off the switch when they are holding things in hands.

### SUMMARY OF THE INVENTION

The problem for the present invention to solve is to provide a voice-activated electric-heating glove, which can realize controlling time and/or voltage that the power supply provides power to the electric heating device through the voice-activated switch and built-in control circuit, so as to control heating time and temperature of the glove.

The technical solution of the present invention is as follows: a voice-activated electric-heating glove, comprising a glove body, wherein the glove also comprises:

a flexible electric heating body arranged inside the glove:

power supply that is used to provide power to the flexible electric heating body to heat the glove:

a voice-activated switch that can power on/off the circuit by voice:

and a control circuit that is electrically connected with the flexible electric heating body, the power supply and the voice-activated switch separately.

A temperature sensor is also provided in the voice-activated electric-heating glove, the control circuit also includes a temperature control module that is connected with the temperature sensor to control heating temperature of the voice-activated electric-heating glove.

The temperature control module comprises a voltage control module and a current control module, the voltage control module is used to control voltage provided to the flexible electric heating body and the current control module is used to control current provided to the flexible electric heating body.

The voice-activated electric-heating glove further comprises a manual switch arranged on the control circuit.

The flexible electric heating body is carbon fiber.

The power supply is a rechargeable battery.

The power supply is a rechargeable lithium battery.

The beneficial effects of the present invention are as follows: 1. the voice-activated switch is used to control start or stop of the electric heating system without need of hand operation, so the user can conveniently control when holding things in both hands; 2. A built-in control circuit is used to control time and/or voltage from the power supply to the electric heating device to control heating time and temperature of the glove, so as to avoid ambustion to user's hands because of high temperature resulted in long-time heating; 3. carbon fiber can be weaved inside the glove fiber to make the glove soft and flexible, so as to avoid inconvenience to the user. The present invention is especially suitable for the outdoor workers at the high and cold areas.

### BRIEF DESCRIPTION OF THE DRAWINGS

FIG. 1 is the structural schematic diagram of the present invention.

FIG. 2 is the elementary flow chart of the control circuit.

### DETAILED DESCRIPTION OF THE PREFERRED EMBODIMENTS

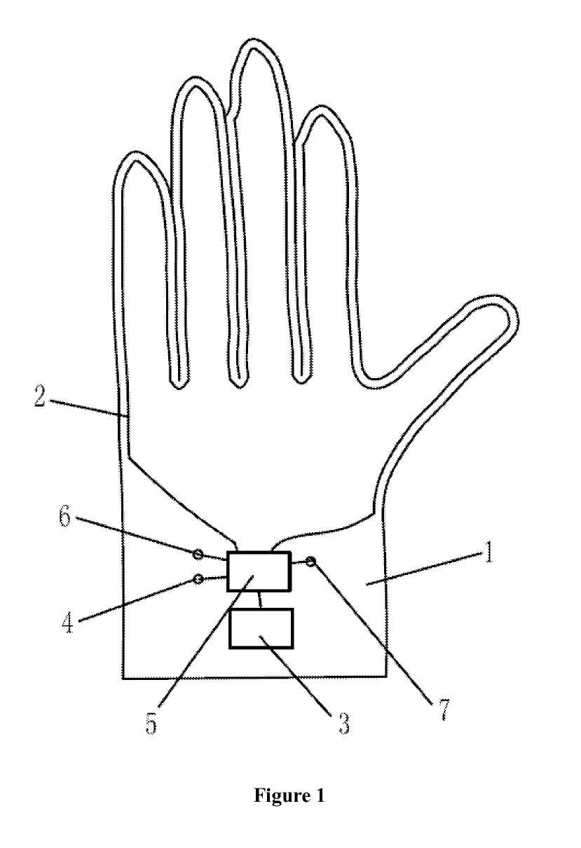

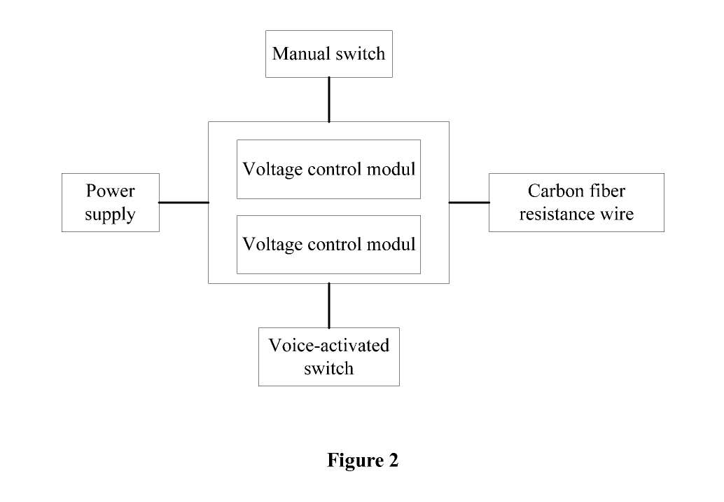

The voice-activated electric-heating glove as shown in FIG. 1 and FIG. 2 comprises a glove body 1, a carbon fiber resistance wire 2, a rechargeable lithium battery 3, a voice-activated switch 4, a control circuit 5, a manual switch 6 and a temperature sensor 7, wherein the control circuit 5 is electrically connected with the carbon fiber resistance wire 2, the rechargeable lithium battery 3, the voice-activated switch 4 and the manual switch 6 separately, and the carbon fiber resistance wire 2 is weaved inside the glove body 1.

The control circuit 5 comprises a temperature control module that comprises a voltage control module 51 and a current control module 52, wherein the voltage control module 51 is used to control voltage provided to the carbon fiber resistance wire 2 and the current control module 52 is used to control current provided to the carbon fiber resistance wire 2, thus to control the temperature in the glove.

Before the gloves leave the factory, the manufacturer can configure different control program to the control circuit 5 according to requirements. The user can press the manual switch 6 on the glove in use, and the control circuit will enter into standby status. At this status, a voice of certain volume to the voice-activated switch 4 can start the control circuit to connect the rechargeable lithium battery 3 and the carbon fiber resistance wire 2, such that the carbon fiber resistance wire 2 can be heated. When the temperature inside the glove reaches a preset value, for example, 40 degrees centigrade, the temperature sensor 7 sends signal to the control circuit 5 which will then adjust the input voltage and current to the carbon resistance wire according to the preset program, so as to realize relatively stable temperature inside the glove. When the heating function is not needed, the user can press the manual switch 6 to turn off the control circuit. If the manual switch is kept on and the time of control circuit under standby status exceeds certain value, the time control module will start to turn off the control circuit. The above parameters like preset temperature and time can be set by the manufacturer during manufacture.

The above embodiment is only for explanation of the present invention but not to limit the present invention. The common technician of the relevant field may make more changes or modifications based on the technical proposal as claimed, but the changes or modifications belong to the protective scope of the present invention.

What is claimed is:

1. A voice-activated electric-heating glove, comprising a glove body, wherein the glove also comprises a flexible electric heating body arranged inside the glove, power supply that is used to provide power to the flexible electric heating body to heat the glove,
a voice-activated switch that can power on/off the circuit by voice,
and a control circuit that is electrically connected with the flexible electric heating body, the power supply and the voice-activated switch separately.

2. The voice-activated electric-heating glove according to claim 1, wherein a temperature sensor is also provided in the voice-activated electric-heating glove, the control circuit also includes a temperature control module that is connected with the temperature sensor to control heating temperature of the voice-activated electric-heating glove.

3. The voice-activated electric-heating glove according to claim 2, wherein the temperature control module comprises a voltage control module and a current control module, the voltage control module is used to control voltage provided to the flexible electric heating body and the current control module is used to control current provided to the flexible electric heating body.

4. The voice-activated electric-heating glove according to claim 1, wherein the voice-activated electric-heating glove further comprises a manual switch arranged on the control circuit.

5. The voice-activated electric-heating glove according to claims 2, wherein the voice-activated electric-heating glove further comprises a manual switch arranged on the control circuit.

6. The voice-activated electric-heating glove according to claims 3, wherein the voice-activated electric-heating glove further comprises a manual switch arranged on the control circuit.

7. The voice-activated electric-heating glove according to claim 1, wherein the flexible electric heating body is carbon fiber.

8. The voice-activated electric-heating glove according to claim 2, wherein the flexible electric heating body is carbon fiber.

9. The voice-activated electric-heating glove according to claim 3, wherein the flexible electric heating body is carbon fiber.

10. The voice-activated electric-heating glove according to claim 1, wherein the power supply is a rechargeable battery.

11. The voice-activated electric-heating glove according to claim 2, wherein the power supply is a rechargeable battery.

12. The voice-activated electric-heating glove according to claim 3, wherein the power supply is a rechargeable battery.

13. The voice-activated electric-heating glove according to claim 6, wherein the power supply is a rechargeable lithium battery.
